(19) United States
(12) Patent Application Publication
(10) Pub. No.: US 2025/0128961 A1
(43) Pub. Date: Apr. 24, 2025

(54) POSITIVE ELECTRODE ACTIVE MATERIAL FOR LITHIUM SECONDARY BATTERIES, METHOD OF MANUFACTURING THE SAME, AND LITHIUM SECONDARY BATTERY INCLUDING THE SAME

(71) Applicants: Hyundai Motor Company, Seoul (KR); Kia Corporation, Seoul (KR); Industry Academy Cooperation Foundation of Sejong University, Seoul (KR)

(72) Inventors: Yong Hoon Kim, Daejeon (KR); Sung Ho Ban, Hwaseong, Gyeonggi-do (KR); Haeun Lee, Incheon (KR); Kyungjung Kwon, Seoul (KR); Seongdeock Jeong, Mokpo, Jeollanam-do (KR); Sanghyuk Park, Seoul (KR); Dongwoo Kim, Seoul (KR)

(21) Appl. No.: 18/602,702

(22) Filed: Mar. 12, 2024

(30) Foreign Application Priority Data
Oct. 20, 2023 (KR) 10-2023-0141305

(51) Int. Cl. C01G 53/00; H01M 4/02; H01M 4/36; H01M 4/505; H01M 4/525; H01M 10/0525; H01M 10/54

(52) U.S. Cl. CPC C01G 53/50; H01M 4/366; H01M 4/505; H01M 4/525; H01M 10/0525; H01M 10/54; C01P 2004/03; C01P 2004/61; C01P 2004/84; C01P 2006/40; H01M 2004/028

(57) ABSTRACT

Disclosed is a positive electrode active material including a core part represented by Chemical Formula 1 below and a shell part represented by Chemical Formula 2 below, the shell part surrounding the core part.

Li(Niₐ₁Mn_{b1}Co_{c1})O₂ [Chemical Formula 1]

Li(Niₐ₂Mn_{b2}Co_{c2})Me_{y}O₂ [Chemical Formula 2]

In the Chemical Formula 1 and the Chemical Formula 2,
a1+b1+c1=1,
a2+b2+c2+y=1,
a1>a2,
Me is at least one metal selected from the group consisting of Na, Al, Fe, Cu, Zn, Mg, Ca, B, Zr, Nb, and a combination thereof, and
y is a total of moles of the at least one metal selected for the Me.

### CROSS-REFERENCE TO THE RELATED APPLICATION

This application claims the benefit of Korean Patent Application No. 10-2023-0141305, filed on Oct. 20, 2023, in the Korean Intellectual Property Office, the disclosure of which is incorporated herein by reference in its entirety.

### BACKGROUND

### Technical Field

The present disclosure relates to a positive electrode active material for lithium secondary batteries, a method of manufacturing the same, and a lithium secondary battery including the same, and more particularly to manufacturing a positive electrode active material using a leaching solution obtained by applying a wet process to a waste battery without a separate solvent extraction process.

### Background

A lithium secondary battery is generally constituted by a positive electrode including a positive electrode active material, a negative electrode including a negative electrode active material, a separator, and an electrolyte, and is charged and discharged by intercalation-deintercalation of lithium ions. The lithium secondary battery has the advantages of high energy density, large electromotive force, and high capacity, whereby the lithium secondary battery is applied to various fields.

In addition to lithium, the positive electrode active material of the lithium secondary battery includes valuable metals such as nickel, manganese, and cobalt, which are relatively expensive metals, and attempts are being made to recover and recycle the metals as raw materials.

In general, valuable metals to be recovered from a waste battery are sequentially extracted through multiple processes using separate extractants, and the extracted valuable metals are recovered and manufactured into a positive electrode active material precursor used to manufacture the positive electrode active material.

When the valuable metals are recovered using separate extractants depending on the metal, however, the process steps are complicated, the extraction cost is increased, the purity is reduced, and the environment is damaged. Furthermore, when the valuable metals are extracted from the leaching solution of the waste battery to manufacture the positive electrode active material precursor, the performance of the positive electrode active material is inferior to the performance of a positive electrode active material made of pure metal in terms of capacity and life maintenance rate of the battery due to various impurities.

### SUMMARY

Therefore, the present disclosure has been made in view of the above problems, and it is an object of the present disclosure to provide a positive electrode active material for lithium secondary batteries that is manufactured through a simplified process without going through the steps of separately extracting valuable metals to be obtained, such as nickel, cobalt, and manganese, from a leaching solution obtained through a waste battery recycling process and separating the metals into individual elements, that is manufactured at low process cost, and that is environmentally friendly, a method of manufacturing the same, and a lithium secondary battery including the same.

In accordance with an aspect of the present disclosure, the above and other objects can be accomplished by the provision of a positive electrode active material including a core part represented by Chemical Formula 1 below and a shell part represented by Chemical Formula 2 below, the shell part being configured to surround the core part.

Li(Niₐ₁Mn_{b1}Co_{c1})O₂ [Chemical Formula 1]

Li(Niₐ₂Mn_{b2}Co_{c2})Me_{y}O₂ [Chemical Formula 2]

In Chemical Formula 1 and Chemical Formula 2,
a1+b1+c1=1,
a2+b2+c2+y=1,
a1>a2,
Me is at least one metal selected from the group consisting of Na, Al, Fe, Cu, Zn, Mg, Ca, B, Zr, Nb, and a combination thereof, and
y is a total of moles of the at least one metal selected for Me.
a1 of Chemical Formula 1 may be set to 0.8≤a1<1, and a2 and y of Chemical Formula 2 may be set to 0<a2≤0.8 and 0.0001≤y≤0.05.

Each of nickel, cobalt, and manganese is present in a concentration gradient in which the concentration thereof gradually changes at the boundary between the core part and the shell part.

In some embodiments, nickel is present in a concentration gradient in which a concentration thereof gradually increases from a center of the positive electrode active material to a surface of the positive electrode active material.

In some embodiments, each of cobalt and manganese is present in a concentration gradient in which a concentration thereof gradually increases from a center of the positive electrode active material to a surface of the positive electrode active material.

The positive electrode active material may have an average particle size of about 5 to about 10 μm.

The core part may have an average particle size of about 4 to about 8 μm, and the shell part may have a thickness of about 1 to about 2 μm.

The volume of the shell part may be about 40 to about 60 volume % based on a total of 100 volume % of the positive electrode active material.

Me may be obtained from a leaching solution of a waste battery.
The 80-cycle capacity retention rate of the positive electrode active material measured in a coin half-cell at 25° C. with an upper limit voltage of 4.3 V may be 94% or more.

In accordance with another aspect of the present disclosure, there is provided a method of manufacturing a positive electrode active material including a core part and a shell part, the method including a first metal-containing solution preparation step of preparing a first metal-containing solution in order to form a core part, a recycling solution preparation step of preparing a recycling solution having a different composition from the first metal-containing solution and including nickel, cobalt, and manganese recycled from a waste battery in order to form a shell part, a core part precursor formation step of forming a core part precursor using the prepared first metal-containing solution, a positive electrode active material precursor formation step of forming a shell part precursor on the surface of the core part precursor using the recycling solution to form a positive electrode active material precursor, and a positive electrode active material formation step of thermally treating the positive electrode active material precursor to form a positive electrode active material.

In the first metal-containing solution preparation step, 70 mol % to less than 100 mol % of nickel may be included based on a total of moles of metal elements included in the first metal-containing solution.

In the recycling solution preparation step, a leaching solution comprising nickel, cobalt, and manganese recycled from the waste battery may be mixed with a second metal-containing solution including nickel, cobalt, and manganese to prepare a recycling solution.

The mixing ratio of the leaching solution to the second metal-containing solution may be 40 mol %:60 mol % to 80 mol %:20 mol %.

In the recycling solution preparation step, a basic solution is mixed with the leaching solution to adjust pH of the leaching solution to 5.5 or less but above 0.

In the core part precursor formation step, an ammonia chelating agent and a basic compound may be added to the prepared first metal-containing solution.

In the positive electrode active material precursor formation step, the core part precursor may be co-precipitated in the recycling solution at a pH of about 10 to about 11 and a co-precipitation time of about 20 to about 60 hours to form the shell part precursor.

The positive electrode active material formation step may include a process of mixing the positive electrode active material precursor with a lithium-containing raw material and firing a mixture resulting therefrom at about 750 to about 850° C. for about 13 to about 20 hours.

A step of washing the positive electrode active material precursor at a temperature of about 5° C. to less than about 10° C. may be further included.

In a further aspect, a vehicle is provided comprising a positive electrode active material as disclosed herein.

Other aspects of the disclosure are disclosed infra.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 shows the results of SEM analysis of precursor particles manufactured according to Examples 1 of the present disclosure.

FIG. 2 shows the results of measurement of the sections of the precursor particles using energy dispersive spectroscopy of precursor particles manufactured according to Examples 1 of the present disclosure.

FIG. 3 shows the results of SEM analysis of precursor particles manufactured according to Examples 1 of the present disclosure.

FIG. 4 shows the results of measurement of the sections of the precursor particles using energy dispersive spectroscopy of precursor particles manufactured according to Examples 1 of the present disclosure.

FIG. 5 show the results of SEM analysis of precursor particles manufactured according to Comparative Example of the present disclosure.

FIG. 6 show the results of measurement of the sections of the precursor particles using energy dispersive spectroscopy of precursor particles manufactured according to comparative Example of the present disclosure.

FIGS. 7 to 9 show the results of charge and discharge tests and the results of measurement of cycle characteristics of batteries using positive electrode active materials manufactured according to Examples 1 and 2 of the present disclosure and a positive electrode active material manufactured according to Comparative Example.

### DETAILED DESCRIPTION OF THE PREFERRED EMBODIMENTS

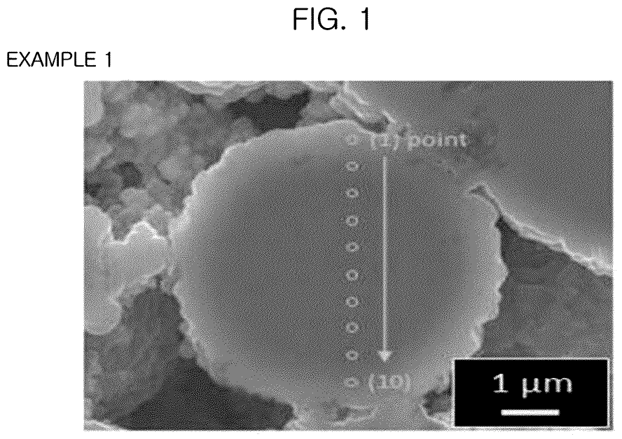

FIG. 1 shows the results of SEM analysis of precursor particles manufactured according to Examples 1 of the present disclosure.

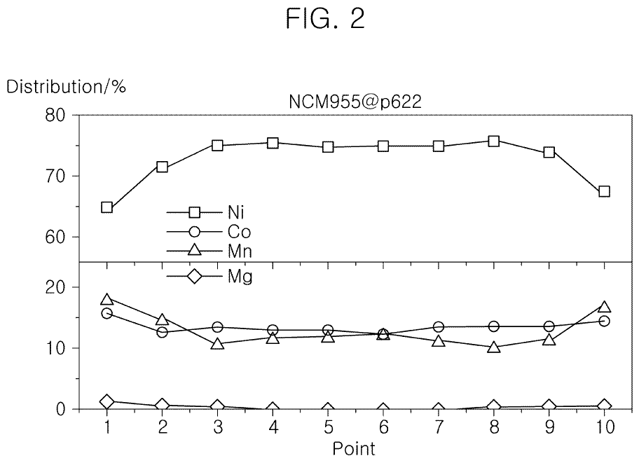

FIG. 2 shows the results of measurement of the sections of the precursor particles using energy dispersive spectroscopy of precursor particles manufactured according to Examples 1 of the present disclosure.

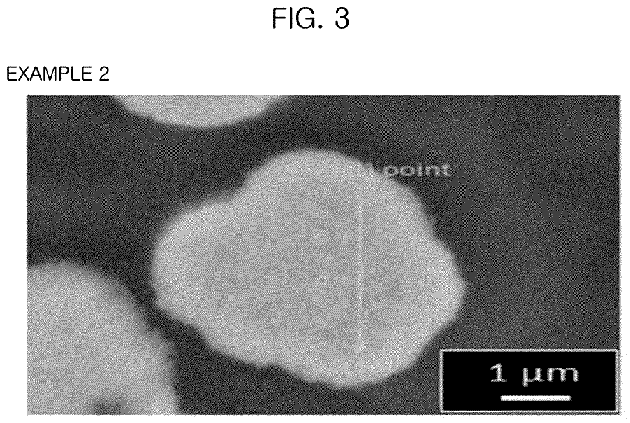

FIG. 3 shows the results of SEM analysis of precursor particles manufactured according to Examples 1 of the present disclosure.

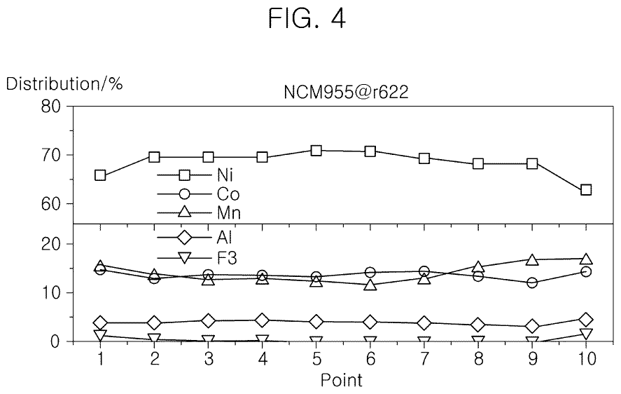

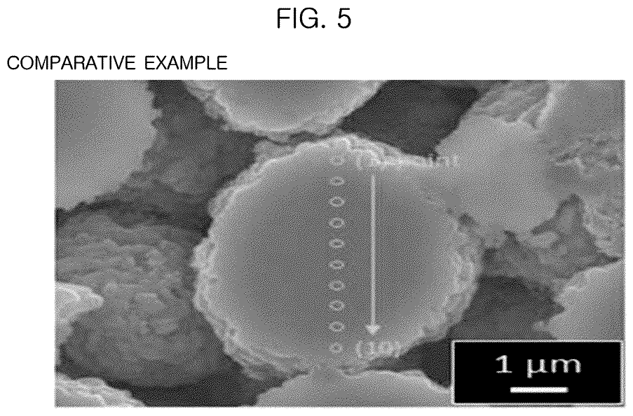

FIG. 4 shows the results of measurement of the sections of the precursor particles using energy dispersive spectroscopy of precursor particles manufactured according to Examples 1 of the present disclosure. FIG. 5 show the results of SEM analysis of precursor particles manufactured according to Comparative Example of the present disclosure.

FIG. 5 show the results of SEM analysis of precursor particles manufactured according to Comparative Example of the present disclosure.

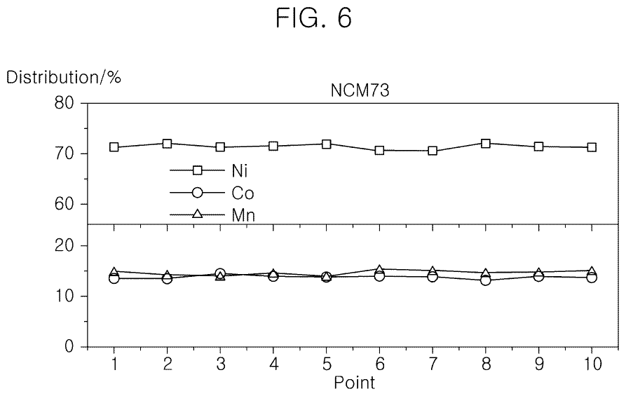

FIG. 6 show the results of measurement of the sections of the precursor particles using energy dispersive spectroscopy of precursor particles manufactured according to comparative Example of the present disclosure.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN). Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, embodiments disclosed in this specification will be described in detail with reference to the accompanying drawings, wherein identical or similar elements will be assigned the same reference numerals regardless of drawing number and duplicate descriptions will be omitted.

In describing the embodiments disclosed in this specification, a detailed description of known technology related thereto will be omitted when the same may obscure the subject matter of the embodiments disclosed in this specification. In addition, it should be noted that the accompanying drawings are provided merely to assist in easy understanding of the embodiments disclosed in this specification, the accompanying drawings do not limit the technical idea disclosed in this specification, and the present disclosure includes all modifications, equivalents, or substitutions included in the idea and technical scope of the present disclosure.

Although terms including ordinal numbers, such as “first” and “second,” may be used herein to describe various elements, these elements should not be limited by these terms. These terms are only used to distinguish one element from another element.

Singular forms are intended to include plural forms as well, unless the context clearly indicates otherwise.

In this specification, it should be understood that the terms “includes,” “has,” etc. specify the presence of stated features, numbers, steps, operations, elements, components, or combinations thereof, but do not preclude the presence or addition of one or more other features, numbers, steps, operations, elements, components, or combinations thereof.

A positive electrode active material according to the present disclosure may be a positive electrode active material including a core part represented by Chemical Formula 1 below and a shell part represented by Chemical Formula 2 below, the shell part being configured to surround the core part.

Li(Niₐ₁Mn_{b1}Co_{c1})O₂ [Chemical Formula 1]

Li(Niₐ₂Mn_{b2}Co_{c2})Me_{y}O₂ [Chemical Formula 2]

In Chemical Formula 1 and Chemical Formula 2,
a1+b1+c1=1,
a2+b2+c2+y=1,
a1>a2, and
Me is at least one metal selected from the group consisting of Na, Al, Fe, Cu, Zn, Mg, Ca, B, Zr, Nb, and a combination thereof.

First, the positive electrode active material may have an average particle size of 5 to 10 μm.

The core part may have an average particle size of 4 to 8 μm.

The shell part may have a thickness of 1 to 2 μm.

The volume of the shell part may be 40 to 60 volume % based on a total of 100 volume % of the positive electrode active material constituted by the core part and the shell part.

The average particle size of the positive electrode active material is 5 to 10 μm, which is relatively small, the volume of the shell part is 40 to 60 volume %, and concentration equilibrium is achieved during a firing process, whereby the positive electrode active material may have a concentration gradient in which concentrations of nickel, cobalt, and manganese gradually change at the boundary between the core part and the shell part.

More specifically, the positive electrode active material has a concentration gradient in which the concentration of nickel in the core part of the positive electrode active material is maintained at high concentration and the concentration of nickel in the shell part is reduced, whereby the positive electrode active material has high capacity, and the content of nickel, which is unstable at high voltage, is reduced at the surface of the positive electrode active material, whereby side reaction with an electrolyte is minimized, and therefore the positive electrode active material may have stable life characteristics.

If the volume of the shell part is very small or the thickness of the shell part is very small, i.e., if the volume of the shell part is less than 40 volume % or less or the thickness of the shell part is 1 μm or less, nickel in the core part, which has a high content of nickel, is diffused into the shell part during heat treatment of the precursor, whereby the content of nickel in the shell part is increased and side reaction with the electrolyte is activated, and therefore the positive electrode active material may have unstable life characteristics.

On the other hand, if the volume of the shell part is large or the thickness of the shell part is very large, i.e., the volume of the shell part is more than 60% or more and the thickness of the shell part is 2 μm or more, nickel in the core part is diffused into the shell part, which has a low content of nickel, during formation of the precursor, whereby a high content of nickel cannot be formed in the core part, and therefore it is difficult to realize high capacity.

Next, the core part will be described. The average particle composition of the core part may be represented by Li(Niₐ₁Mn_{b1}Co_{c1})O₂, where 0.8≤a1<1. A nickel-rich positive electrode active material having a nickel content of the core part of 80 mol % or more may be formed such that the positive electrode active material has high capacity.

The average particle composition of the shell part may be represented by Li(Niₐ₂Mn_{b2}Co_{c2})Me_{y}O₂, where 0<a2≤0.8 and 0.0001≤y≤0.05. At this time, the shell part may be composed so as to have a lower content of nickel than the core part (a1>a2). This serves to minimize side reaction with the electrolyte by forming a lower content of nickel on the surface of the positive electrode active material.

Since nickel is unstable at high temperatures, it is important that the surface of the positive electrode active material has a low content of nickel. The shell part is composed such that the content of nickel is between 40 mol % to 80 mol %, whereby side reaction of nickel with the electrolyte may be minimized, and therefore the positive electrode active material may have stable life characteristics.

The shell part of the positive electrode active material will be described in more detail. The shell part of the positive electrode active material may include Me obtained from a leaching solution, wherein Me obtained from the leaching solution may be at least one metal selected from the group consisting of Na, Al, Fe, Cu, Zn, Mg, Ca, B, Zr, Nb, and a combination thereof.

As interest in and utilization of secondary batteries have increased in recent years, recycling of waste batteries has become essential. In some embodiments of the present disclosure, 30 mol % to 40 mol % of the positive electrode active material is constituted by a material obtained from a leaching solution, which is a solution of recycled waste batteries.

Specifically, in some embodiments of the present disclosure, a separate solvent extraction step is not further performed for a leaching solution obtained by melting the internal materials of a waste battery, a process of adjusting the composition of nickel, cobalt, and manganese in the leaching solution is performed, and a shell part precursor is formed from the leaching solution subjected to the composition adjustment process.

The 80-cycle capacity retention rate of the positive electrode active material according to the present disclosure measured in a coin half-cell at 25° C. with an upper limit voltage of 4.3 V is about 95%, which is excellent.

Next, a method of manufacturing a positive electrode active material according to an exemplary embodiment of the present disclosure will be described. The method of manufacturing the positive electrode active material according to an exemplary embodiment of the present disclosure, which is a method of manufacturing a positive electrode active material including a core part and a shell part, may include a first metal-containing solution preparation step of preparing a first metal-containing solution in order to form a core part, a recycling solution preparation step of preparing a recycling solution having a different composition from the first metal-containing solution and including nickel, cobalt, and manganese recycled from a waste battery in order to form a shell part, a core part precursor formation step of forming a core part precursor using the prepared first metal-containing solution, a positive electrode active material precursor formation step of forming a shell part precursor on the surface of the core part precursor using the recycling solution to form a positive electrode active material precursor, and a positive electrode active material formation step of thermally treating the positive electrode active material precursor to form a positive electrode active material.

First, the first metal-containing solution preparation step will be described. This step is a step of preparing a first metal-containing solution including nickel, cobalt, and manganese. The first metal-containing solution is a solution that forms a precursor of a core part, wherein 80 mol % or more to less than 100 mol % of nickel may be included based on the total moles of metal elements in the first metal-containing solution. That is, the core part may include 80 mol % or more to less than 100 mol % of nickel based on the total moles of metal elements in the first metal-containing solution that forms the precursor to the core part in order to realize a nickel-rich composition so as to realize high capacity.

Next, the recycling solution preparation step will be described. This step is a step of preparing a recycling solution having a different composition from the first metal-containing solution and including nickel, cobalt, and manganese recycled from a waste battery in order to form a shell part.

The present disclosure aims to recycle waste batteries. Internal materials of a waste battery are melted in a wet process to obtain a leaching solution. At this time, the leaching solution may include recycled nickel, cobalt, and manganese, and may further include other metals and anions. The other metals may include one or more metals selected from the group consisting of Na, Al, Fe, Cu, Zn, Mg, Ca, B, Zr, Nb, and a combination thereof, and Cl, S, and F may be included as the anions.

In the recycling solution preparation step, the leaching solution including nickel, cobalt, and manganese recycled from the waste battery may be mixed with a second metal-containing solution including nickel, cobalt, and manganese to prepare a recycling solution.

Conventionally, a leaching solution obtained by melting internal materials of a discharged waste battery through physical and chemical treatments is subjected to a solvent extraction process to extract nickel, cobalt, and manganese from the leaching solution. However, a solvent used in the solvent extraction process is not eco-friendly, the process is complicated due to additional processes, a lot of time is required, and the price of the solvent used is high, whereby the cost is increased.

In some embodiments of the present disclosure, the leaching solution is mixed with a second metal-containing solution that serves to control the composition of nickel, cobalt, and manganese without the solvent extraction step to form a recycling solution that is used for shell part precursor synthesis in order to form the shell part precursor. Since the solvent extraction step is not performed, the process is simplified. Furthermore, expensive solvents are not used, whereby the cost is reduced, and non-environmentally friendly solvents are not used, whereby environmental benefits are obtained.

At this time, the mixing ratio of the leaching solution to the second metal-containing solution may be 40 mol %:60 mol % to 80 mol %:20 mol %. Since the leaching solution has too low contents of nickel, cobalt, and manganese to form the shell part precursor, the leaching solution may be mixed with a second metal-containing solution including nickel, cobalt, and manganese to prepare a recycling solution utilized to form the shell part precursor.

At this time, the mixing ratio of the leaching solution to the second metal-containing solution may vary depending on a desired composition of the shell part and a desired composition of the leaching solution. If the proportion of the second metal-containing solution in the recycling solution is 60 mol % or more, however, the content of nickel in the shell part precursor becomes excessive, and side reaction with the electrolyte may easily occur, whereby life stability of the positive electrode active material is reduced.

If the proportion of the second metal-containing solution in the recycling solution is 20 mol % or less, the content of nickel, cobalt, and manganese in the recycling solution is lowered, resulting in a decrease in the nickel content of the shell part and a decrease in the average capacity of the positive electrode active material.

In addition, a process of mixing a basic solution with the leaching solution to adjust pH of the leaching solution to 5.5 may be further included in the recycling solution preparation step. This is because a leaching solution obtained from a waste battery includes various sulfides, which can be controlled by adjusting pH.

Specifically, the leaching solution is a solution including a large number of metal sulfides, which are acidic. When pH is increased by adding NaOH to the leaching solution, the metal sulfides dissolved in the leaching solution become metal hydroxides. The solubility of the metal hydroxides decreases with increasing pH, and impurities other than nickel, cobalt, and manganese may be precipitated when pH is 5.5 or less. Therefore, metals other than nickel, cobalt, and manganese, which are desired valuable metals, are precipitated through pH adjustment such that impurities in the recycling solution can be controlled.

Next, the core part precursor formation step will be described. The core part precursor formation step is a step of form a core part precursor through the first metal-containing solution. More specifically, an ammonia chelating agent and a basic compound are mixed in the first metal-containing solution to form a core part precursor. The ammonia chelating agent may be NH₄OH, (NH₄)₂SO₄, NH₄NO₃, NH₄Cl, CH₃COONH₄, or NH₄CO₃, and one or a mixture of two or more thereof may be used. In addition, the ammonia chelating agent may be used in the form of an aqueous solution. At this time, water, or a mixture of water and an organic solvent (specifically, alcohol) that can be homogeneously mixed with water may be used as a solvent. The ammonia chelating agent may be added so as to have a molar ratio of 0.5 to 1 per mole of the first metal-containing solution.

The basic compound may be a hydroxide of an alkali metal or alkaline earth metal, such as NaOH, KOH, or Ca(OH)₂, or a hydrate thereof, and one or a mixture of two or more thereof may be used.

Co-precipitation reaction may be carried out at a temperature of 40° C. to 60° C. under an inert atmosphere, such as nitrogen or argon. In addition, a stirring process may optionally be performed to increase the reaction rate during the co-precipitation reaction. At this time, the stirring speed may be 700 rpm to 1500 rpm. In addition, the co-precipitation reaction may be carried out under conditions of pH 10.0 to 12.0. When the co-precipitation reaction is carried out within the above pH range, precursor particles may be manufactured without causing size change or particle splitting of the precursor that is manufactured and without producing various oxides by side reaction due to elution of metal ions from the surface of the precursor.

Next, the positive electrode active material precursor formation step will be described. The positive electrode active material precursor formation step is a step of forming a shell part precursor on the surface of the core part precursor using the recycling solution to form a positive electrode active material precursor. The shell part may be formed on the surface of the core part precursor through the same co-precipitation reaction as in the core part precursor formation step described above. In this case, the co-precipitation time may be set in consideration of the thickness of the shell part precursor and the thickness of the positive electrode active material precursor.

For example, the co-precipitation conditions for the core part precursor may be set such that the recycling solution has a pH of 10 to 11 and the co-precipitation time is 20 to 60 hours.

Next, the positive electrode active material formation step will be described. This step is a step of mixing the positive electrode active material precursor and a lithium-containing raw material and firing the same to synthesize a positive electrode active material. A commonly used material may be used without any special restrictions as the lithium-containing raw material. For example, lithium-containing sulfate, nitrate, acetate, carbonate, oxalate, citrate, halide, hydroxide or oxyhydroxide may be used. However, the lithium-containing raw material is not particularly restricted as long as the lithium-containing raw material is soluble in water. Specifically, one or a mixture of two or more selected from the group consisting of Li₂CO₃, LiNO₃, LiNO₂, LiOH, LiOH·H₂O, LiH, LiF, LiCl, LiBr, LiI, CH₃COOLi, Li₂O, Li₂SO₄, CH₃COOLi, and Li₃C₆H₅O₇ may be used as the lithium-containing raw material.

Firing may be performed at 730° C. to 800° C. If the firing temperature is below 730° C., there is a risk of decreasing the discharge capacity per unit weight, decreasing the cycle characteristics, and decreasing the operating voltage due to retention of unreacted raw material. If the firing temperature exceeds 800° C., there is a risk of decreasing the discharge capacity per unit weight, decreasing the cycle characteristics, and decreasing the operating voltage due to the generation of a side reactant.

The firing step may be performed under an oxidizing atmosphere, such as air or oxygen, or under a reducing atmosphere including nitrogen or hydrogen for 13 to 20 hours. The firing process under these conditions allows sufficient diffusion reaction between particles to occur, and also allows diffusion of metal even in areas with a constant inner metal concentration, whereby a metal oxide with a continuous metal concentration distribution from the center to the surface may be manufactured.

Additionally, a process of washing the synthesized positive electrode active material prior to the firing step may be further included. The washing step may be performed at a temperature of 5° C. to less than 10° C. When the positive electrode active material is washed within the above temperature range, lithium by-products present in the positive electrode active material may be effectively removed. If the washing temperature exceeds 10° C., however, the positive electrode active material may be overwashed, whereby life characteristics and capacity characteristics may be lowered.

A step of thermally treating the positive electrode active material may be further included. The washed positive electrode active material may be thermally treated at 600 to 800° C. for 2 to 10 hours. Unremoved by-products, such as LiOH or Li₂CO₃, may be effectively removed through the heat treatment process, whereby the positive electrode active material is preferably used in a lithium secondary battery.

In addition, the present disclosure provides a lithium secondary battery including the positive electrode active material according to the present disclosure. The lithium battery includes a positive electrode including the positive electrode active material having the configuration described above, a negative electrode including a negative electrode active material, and a separator disposed therebetween. In addition, the lithium battery includes an electrolyte present in the positive electrode, the negative electrode, and the separator by impregnation. A material capable of reversibly absorbing and releasing lithium ions is preferably used as the negative electrode active material. For example, a material including artificial graphite, natural graphite, or graphitized carbon fiber may be used, and lithium metal may also be used as the negative electrode active material. The electrolyte may be a liquid electrolyte including a lithium salt and a non-aqueous organic solvent, or may be a polymer gel electrolyte.

The present disclosure will now be described in more detail with reference to Examples and Comparative Example. However, the present disclosure is not limited to the examples.

### Example 1

Manganese sulfate hydrate (MnSO₄·1H₂O), nickel sulfate hydrate (NiSO₄·6H₂O), and cobalt sulfate hydrate (CoSO₄·7H₂O) were used as a first metal-containing solution. Distilled water, as a solvent, was added to manganese sulfate hydrate (MnSO₄·1H₂O), nickel sulfate hydrate (NiSO₄·6H₂O), and cobalt sulfate hydrate (CoSO₄·7H₂O) to manufacture a first metal-containing solution. In addition, the first metal-containing solution, which is a solution for a core part, was formed such that the molar ratio of nickel to cobalt to manganese was 90:5:5.

For the first metal-containing solution manufactured as described above, 2M of NaOH was used as a basic aqueous solution, and the molar ratio of the first metal-containing solution to NaOH (first metal aqueous solution:precipitant) was 1:1 to 2. In addition, 1M of NH₄OH was used as an ammonium chelating agent, and the molar ratio of the first metal-containing solution to the ammonium chelating agent was 1:0.5 to 1. The mixture of the first metal-containing solution, NaOH, and the ammonium chelating agent was introduced into a continuous reactor using a metering pump. Subsequently, nitrogen gas from the continuous reactor was supplied to a reactor at a rate of 0.5 liters/min to remove dissolved oxygen, and stirring was performed while the temperature of the reactor was maintained at 50° C. and the stirring speed was controlled to about 1000 rpm to form a core part precursor.

Next, a recycling solution used to form a shell part precursor will be described. A leaching solution is obtained from a waste battery through wet processing. In the case of Example 1, NaOH is further added to the leaching solution such that the leaching solution has a pH of 5.5. A process of adjusting pH of the leaching solution to 5.5 to precipitate impurities other than nickel, cobalt, and manganese, thereby controlling the impurities in the leaching solution, is performed. The leaching solution with controlled impurities other than nickel, cobalt, and manganese has a molar ratio of nickel to cobalt to manganese of 32:15:10, with small amounts of other unremoved impurities.

Manganese sulfate hydrate (MnSO₄·1H₂O), nickel sulfate hydrate (NiSO₄·6H₂O), and cobalt sulfate hydrate (CoSO₄·7H₂O) were used as a second metal-containing solution. Manganese sulfate hydrate (MnSO₄·1H₂O), nickel sulfate hydrate (NiSO₄·6H₂O), and cobalt sulfate hydrate (CoSO₄·7H₂O) were further added to the leaching solution to form a molar ratio of nickel to cobalt to manganese of 60:20:20. Other impurities derived from the leaching solution were mixed in small amounts.

Subsequently, a process of forming a positive electrode active material precursor is performed. In order to form a shell part precursor on the surface of the core part precursor formed from the first metal-containing solution, the first metal-containing solution is changed to the second metal-containing solution during the co-precipitation reaction in the same manner as the core part precursor formation process to form a positive electrode active material precursor having a core-shell structure.

LiOH, as a lithium salt, was mixed in the positive electrode active material precursor, the mixture was heated at a temperature increase rate, and the mixture was fired at 750° C. for 20 hours, whereby final active material particles were obtained. The size of the final active material particles was 6 to 8 μm.

### Example 2

Manganese sulfate hydrate (MnSO₄·1H₂O), nickel sulfate hydrate (NiSO₄·6H₂O), and cobalt sulfate hydrate (CoSO₄·7H₂O) were used as a first metal-containing solution. Distilled water, as a solvent, was added to manganese sulfate hydrate (MnSO₄·1H₂O), nickel sulfate hydrate (NiSO₄·6H₂O), and cobalt sulfate hydrate (CoSO₄·7H₂O) to manufacture a first metal-containing solution. In addition, the first metal-containing solution was formed such that the molar ratio of nickel to cobalt to manganese was 90:5:5.

For the first metal-containing solution manufactured as described above, 2M of NaOH was used, and the molar ratio of the first metal-containing solution to NaOH (metal aqueous solution:precipitant) was 1:1 to 2. In addition, 1M of NH₄OH was used as an ammonium chelating agent, and the molar ratio of the first metal-containing solution to the ammonium chelating agent was 1:0.5 to 1. The mixture of the first metal-containing solution, NaOH, and the ammonium chelating agent was introduced into a continuous reactor using a metering pump. Subsequently, nitrogen gas from the continuous reactor was supplied to a reactor at a rate of 0.5 liters/min to remove dissolved oxygen, and stirring was performed while the temperature of the reactor was maintained at 50° C. and the stirring speed was controlled to about 1000 rpm to form a core part precursor.

Subsequently, a process of preparing a recycling solution to form a shell part precursor is performed. A leaching solution is obtained from a waste battery through wet processing. The leaching solution is configured such that the molar ratio of nickel to cobalt to manganese to aluminum is 41:12:6:7.6 and other impurities are present in small amounts. A second metal-containing solution was formed using manganese sulfate hydrate (MnSO₄·1H₂O), nickel sulfate hydrate (NiSO₄·6H₂O), and cobalt sulfate hydrate (CoSO₄·7H₂O). Manganese sulfate hydrate (MnSO₄·1H₂O), nickel sulfate hydrate (NiSO₄·6H₂O), and cobalt sulfate hydrate (CoSO₄·7H₂O) were further added to the leaching solution to form a molar ratio of nickel to cobalt to manganese of 60:20:20. Other impurities derived from the leaching solution were mixed.

Subsequently, a process of forming a positive electrode active material precursor is performed. In order to form a shell part precursor on the surface of the core part precursor formed from the first metal-containing solution, the co-precipitation reaction is carried out in the same manner using the recycling solution to form a positive electrode active material precursor having a core-shell structure.

LiOH, as a lithium salt, was mixed in the positive electrode active material precursor, the mixture was heated at a temperature increase rate of 3 to 5° C./min, and the mixture was fired at 750° C. for 20 hours, whereby final active material particles were obtained. The size of the final active material particles was 5 to 6 μm.

### Comparative Example

In Comparative Example, a positive electrode active material having an average composition represented by LiNi_{0.73}Co_{0.13}Mn_{0.14}O₂, was formed using a metal-containing solution having a molar ratio of nickel to cobalt to manganese of 73:13:14 through the same co-precipitation reaction as in Examples 1 and 2 without using a leaching solution. The size of the formed positive electrode active material was 6 to 8 μm.

The following table shows the results of analyzing the positive electrode active material precursors of Examples 1 and 2 and Comparative Example through inductively coupled plasma (ICP).

TABLE 1

| | Example 1 | Example 2 | Comparative |
|---|---|---|---|
| Element | (mole %) | (mole %) | Example (mole %) |
| Ni | 72.43 | 69.88 | 72.77 |
| Co | 14.42 | 12.78 | 13.02 |
| Mn | 14.34 | 13.07 | 14.21 |
| Na | 0.13 | 0.12 | — |
| Al | 0.10 | 3.70 | — |
| Fe | 0.01 | 0.11 | — |
| Cu | 0.01 | 0.02 | — |
| Zn | 0.01 | 0.01 | — |
| Mg | 0.45 | 0.21 | — |
| Ca | 0.1 | 0.10 | — |

Next, the results of the SEM analysis and energy dispersive spectroscopy analysis of Examples 1 and 2 and Comparative Example will be described with reference to FIGS. 1 to 6.

Referring first to FIG. 1 to 2, the result of SEM analysis of a positive electrode active material precursor particle of Example 1 and the result of measurement of the section of the precursor particle using energy dispersive spectroscopy are shown. A core part precursor was manufactured using a first metal-containing solution having a high content of nickel, and a shell part precursor was manufactured by a recycling solution with a relatively low content of nickel. Consequently, it can be seen that the positive electrode active material precursor has a concentration gradient in which the concentration of nickel gradually decreases from point 5, which is the center of the positive electrode active material precursor, to point 10 or point 1, which is the surface of the positive electrode active material precursor.

The core part precursor was manufactured using a first metal-containing solution having a low content of cobalt and manganese, and the shell part precursor was manufactured using a recycling solution having a relatively high content of cobalt and manganese. Consequently, it can be seen that the positive electrode active material precursor has a concentration gradient in which the concentration of cobalt and manganese gradually increases from point 5, the center of the positive electrode active material precursor, to point 10 or point 1, the surface of the positive electrode active material precursor.

In the case of Example 1, a process of adjusting pH of the leaching solution to remove impurities was performed, and therefore it can be seen that the impurities, such as Al and Fe, are very low, unlike the result of Example 2, which will be described below, and it can also been seen that a small amount of unremoved Mg is distributed in the core part precursor and the shell part precursor.

Next, the result of SEM analysis of a positive electrode active material precursor particle of Example 2 and the result of measurement of the section of the precursor particle using energy dispersive spectroscopy will be described with reference to FIG. 3 to 4. A core part precursor was manufactured using a first metal-containing solution having a high content of nickel, and a shell part precursor was manufactured by a recycling solution with a relatively low content of nickel. Consequently, it can be seen that the positive electrode active material precursor has a concentration gradient in which the concentration of nickel gradually decreases from point 5, which is the center of the positive electrode active material precursor, to point 10 or point 1, which is the surface of the positive electrode active material precursor.

The core part precursor was manufactured using a first metal-containing solution having a low content of cobalt and manganese, and the shell part precursor was manufactured using a recycling solution having a relatively high content of cobalt and manganese. Consequently, it can be seen that the positive electrode active material precursor has a concentration gradient in which the concentration of cobalt and manganese gradually increases from point 5, the center of the positive electrode active material precursor, to point 10 or point 1, the surface of the positive electrode active material precursor.

In addition, it can be seen that Al and Fe derived from the leaching solution are distributed throughout the core part precursor and the shell part precursor with a low content. This is because, unlike Example 1, Example 2 does not go through the process of adjusting pH of the leaching solution, whereby it can be seen that Al and Fe are included, unlike Example 1.

Next, the result of SEM analysis of a positive electrode active material precursor of Comparative Example and the result of measurement of the section of the precursor particle using energy dispersive spectroscopy will be described with reference to FIG. 3. It can be seen that nickel, cobalt, and manganese are evenly distributed in the positive electrode active material precursor in a molar ratio of 73:13:14 with no overall concentration gradient.

Next, the results of charge and discharge tests and the results of measurement of cycle characteristics of batteries using the positive electrode active materials manufactured according to Examples 1 and 2 of the present disclosure and the positive electrode active material manufactured according to Comparative Example will be described with reference to FIGS. 4 to 6.

For an electrode, a solution of 1 mole of LiPF₆ dissolved in a solvent containing ethylene carbonate and ethyl methyl carbonate in a volume ratio of 3:7 was used as an electrolyte. A half-cell was manufactured using lithium foil as a negative electrode and was evaluated.

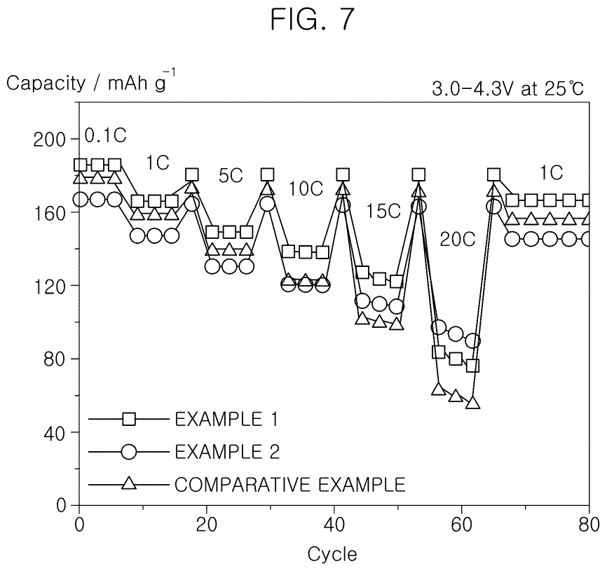

First, as shown in FIG. 7, a voltage range of charge and discharge at 25° C. was 3.0 to 4.3 V, and charging and discharging were performed while variously changing the rate. The x-axis of FIG. 7 is the number of charge and discharge cycles and the y-axis is the capacity.

It can be seen from FIG. 7 that Example 1 has a higher capacity than Comparative Example even at a low rate below 1° C. It can also be seen that the capacity of Example 1 is still higher than the capacity of Comparative Example at a high rate of 15 C or more.

In the case of Example 2, it can be seen that the initial capacity is low due to excessive Al impurities at a low rate below 1° C. but the capacity of Example 2 is higher than the capacity of Comparative Example at a high rate of 15 C or more.

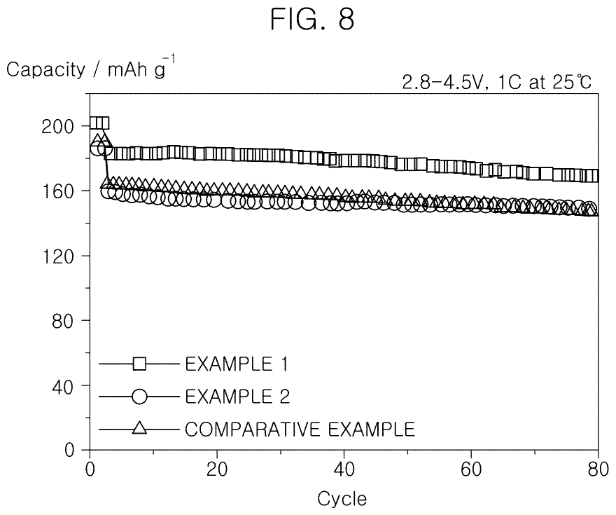

Next, as shown in FIG. 8, a voltage range of charge and discharge at 25° C. was 2.8 to 4.5 V, and charging and discharging were performed at a rate of 1.0 C. It can be seen that, for Examples 1 and 2, the side reaction between Ni unstable at high voltage and the electrolyte is minimized due to a low Ni composition on the surface, resulting in higher life characteristics than Comparative Example. More specifically, it can be seen that more capacity is preserved in Example 1 and Example 2 over 60 cycles than in Comparative Example.

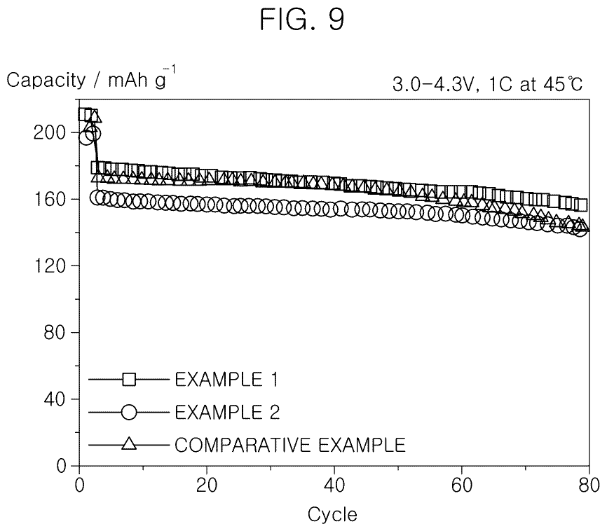

As shown in FIG. 9, a voltage range of charge and discharge at 45° C. was 3.0 to 4.5 V, and charging and discharging were performed at a rate of 1.0 C. It can be seen that Examples 1 and 2 exhibit improved thermal stability due to high Mn composition on the surface and have a higher lifetime retention rate than Comparative Example at the high temperature evaluation of 45° C. More specifically, it can be seen that Comparative Example shows a sharp loss of capacity starting at approximately 40 cycles while Examples 1 and 2 show a stable change in capacity unlike Comparative Example.

As is apparent from the above description, according to the present disclosure, a leaching solution obtained through a waste battery recycling process is used in a positive electrode active material precursor formation process without going through the steps of separately extracting valuable metals and separating the metals into individual elements.

As a result, the process may be simplified, and the process cost may be reduced. In addition, a solvent, which is conventionally used, is not used to extract nickel, cobalt, and manganese, which is environmentally friendly.

In addition, a positive electrode active material exhibits excellent capacity at a high rate due to the doping effect caused by impurities present in the leaching solution, and side reaction with an electrolyte is minimized due to a low nickel composition of a shell part, resulting in stable life characteristics. Furthermore, improved thermal compatibility is exhibited due to a high manganese composition of the shell part, whereby a high life retention rate at high temperatures is achieved.

While the present disclosure has been described with reference to the accompanying drawings and the preferred embodiments described above, the present disclosure is not limited thereto but is limited by the appended claims. Accordingly, a person having ordinary skill in the art may make various modifications and modifications to the present disclosure without departing from the technical ideas of the appended claims.

What is claimed is:

1. A positive electrode active material comprising:
a core part comprising a material represented by Chemical Formula 1: Li(Niₐ₁Mn_{b1}Co_{c1})O₂; and
a shell part comprising a material represented by Chemical Formula 2: Li(Niₐ₂Mn_{b2}Co_{c2})Me_{y}O₂, the shell part surrounding the core part:
wherein in the Chemical Formula 1 and the Chemical Formula 2,
a1+b1+c1=1,
a2+b2+c2+y=1,
a1>a2,
Me is at least one metal selected from the group consisting of Na, Al, Fe, Cu, Zn, Mg, Ca, B, Zr, Nb, and a combination thereof, and
y is a total of moles of the at least one metal selected for the Me.

2. The positive electrode active material according to claim 1, wherein
a1 of Chemical Formula 1 is set to 0.8≤a1<1, and
a2 and y of Chemical Formula 2 are set to 0<a2≤0.8 and 0.0001≤y≤0.05.

3. The positive electrode active material according to claim 1, wherein each of nickel, cobalt, and manganese is present in a concentration gradient in which a concentration thereof gradually changes from a center of the positive electrode active material to a surface of the positive electrode active material.

4. The positive electrode active material according to claim 1, wherein nickel is present in a concentration gradient in which a concentration thereof gradually increases from a center of the positive electrode active material to a surface of the positive electrode active material.

5. The positive electrode active material according to claim 1, wherein each of cobalt and manganese is present in a concentration gradient in which a concentration thereof gradually decreases from a center of the positive electrode active material to a surface of the positive electrode active material.

6. The positive electrode active material according to claim 1, wherein the positive electrode active material has an average particle size of about 5 to about 10 μm.

7. The positive electrode active material according to claim 1, wherein the core part has an average particle size of about 4 to about 8 μm.

8. The positive electrode active material according to claim 1, wherein the shell part has a thickness of about 1 to about 2 μm.

9. The positive electrode active material according to claim 1, wherein the volume of the shell part is about 40 to about 60 volume % based on a total of 100 volume % of the positive electrode active material.

10. The positive electrode active material according to claim 1, wherein Me is obtained from a leaching solution of a waste battery.

11. The positive electrode active material according to claim 1, wherein an 80-cycle capacity retention rate of the positive electrode active material measured in a coin half-cell at 25° C. with an upper limit voltage of 4.3 V is about 91% or more.

12. A method of manufacturing a positive electrode active material comprising a core part and a shell part, the method comprising:
a first metal-containing solution preparation step of preparing a first metal-containing solution;
a recycling solution preparation step of preparing a recycling solution having a different composition from the first metal-containing solution and comprising nickel, cobalt, and manganese recycled from a waste battery;
a core part precursor formation step of forming a core part precursor using the prepared first metal-containing solution;
a positive electrode active material precursor formation step of forming a shell part precursor on a surface of the core part precursor using the recycling solution to form a positive electrode active material precursor; and
a positive electrode active material formation step of thermally treating the positive electrode active material precursor to form a positive electrode active material.

13. The method according to claim 12, wherein, in the first metal-containing solution preparation step, about 70 to about 100 mol % of nickel is included based on a total of 100 mol % of metal elements included in the first metal-containing solution.

14. The method according to claim 12, wherein, in the recycling solution preparation step, a leaching solution comprising nickel, cobalt, and manganese recycled from the waste battery is mixed with a second metal-containing solution comprising nickel, cobalt, and manganese to prepare a recycling solution.

15. The method according to claim 14, wherein a mixing ratio of the leaching solution to the second metal-containing solution is about 40 mol %:about 60 mol % to about 80 mol %:about 20 mol %.

16. The method according to claim 12, wherein, in the recycling solution preparation step, a basic solution is mixed with a leaching solution comprising nickel, cobalt, and manganese recycled from the waste battery to adjust pH of the leaching solution to about 5.5 or less but above 0.

17. The method according to claim 12, wherein, in the core part precursor formation step, the prepared first metal-containing solution and an ammonia chelating agent are mixed so as to have a molar ratio of about 1:0.5 to 1 and a pH of about 10 to about 12, and a mixture is stirred at about 700 to about 1500 rpm at a temperature of about 40 to about 60° C. under a nitrogen atmosphere to form a core part precursor.

18. The method according to claim 12, wherein, in the positive electrode active material precursor formation step, the core part precursor is co-precipitated in the recycling solution at a pH of about 10 to about 11 and a co-precipitation time of about 20 to about 60 hours to form the shell part precursor.

19. The method according to claim 12, wherein the positive electrode active material formation step comprises a process of mixing the positive electrode active material precursor with a lithium-containing raw material and firing a mixture resulting therefrom at about 750 to about 850° C. for about 13 to about 20 hours.

20. A Li-ion battery comprising the positive electrode active material of claim 1.
